(19) United States
(12) Patent Application Publication
(10) Pub. No.: US 2022/0063498 A1
(43) Pub. Date: Mar. 3, 2022

(54) DRIVING ASSISTANCE DEVICE FOR VEHICLE, DRIVING ASSISTANCE METHOD FOR VEHICLE, AND PROGRAM

(71) Applicant: Toyota Jidosha Kabushiki Kaisha, Toyota-shi Aichi-ken (JP)

(72) Inventors: Takeshi Matsumura, Toyota-shi (JP); Hiroaki Ito, Toyota-shi (JP); Kohsuke Fujii, Toyota-shi (JP)

(73) Assignee: Toyota Jidosha Kabushiki Kaisha, Toyota-shi Aichi-ken (JP)

(21) Appl. No.: 17/378,260

(22) Filed: Jul. 16, 2021

(30) Foreign Application Priority Data
Aug. 31, 2020 (JP) 2020-145297

(51) Int. Cl. B60R 1/00; G06T 7/70; G06K 9/62; G06K 9/00; B60Q 9/00

(52) U.S. Cl. CPC B60R 1/00; G06T 7/70; G06K 9/6215; G06K 9/00818; B60R 2300/80; G06T 2207/30252; B60R 2300/10; B60R 2300/20; B60Q 9/00

(57) ABSTRACT

A driving assistance device for a vehicle includes a front camera and an image processing ECU configured to detect a display object present forward of a vehicle and recognize display content of the detected display object, and a driving assistance ECU configured to execute driving assistance control for assisting a driver in a case where the display object is detected by the front camera and the image processing ECU. The driving assistance ECU sets an assistance level of the driving assistance control high when the detected display object is detected multiple times in the past, and a rate of coincidence of recognition results indicating the number of times determined to be the same display content to the number of detection times is equal to or greater than a first threshold value, compared to when the rate of coincidence of the recognition results is less than the first threshold value.

### CROSS-REFERENCE TO RELATED APPLICATION

This application claims priority to Japanese Patent Application No. 2020-145297 filed on Aug. 31, 2020, incorporated herein by reference in its entirety.

### BACKGROUND

### 1. Technical Field

The present disclosure relates to a driving assistance device for a vehicle, a driving assistance method for a vehicle, and a program.

### 2. Description of Related Art

Hitherto, a driving assistance device for a vehicle that detects a display object, such as a traffic sign, present outside a vehicle and performs display indicating display content of the detected display object toward a driver is known. For example, Japanese Unexamined Patent Application Publication No. 2017-97681 (JP 2017-97681 A) discloses a driving assistance device having a camera configured to detect a specific traffic sign indicating prohibition of forward movement in a direction other than a designated direction forward of a vehicle, and a display device configured to perform caution display and an alarm device configured to give an alarm when the vehicle moves in a direction different from the designated direction of the specific traffic sign detected by the camera. With the driving assistance device, it is possible to provide a driving assistance control corresponding to the display content of the detected display object.

### SUMMARY

In the driving assistance device disclosed in JP 2017-97681 A, when a traffic sign is erroneously detected by the camera, the display device performs the caution display and the alarm device gives the alarm (generates alert sound) even though a driver performs a driving operation adapted to display content of the traffic sign. Accordingly, when the camera erroneously detects the traffic sign, there is a concern that the driver feels troublesomeness in the caution display by the display device and the alert sound by the alarm device.

The disclosure has been accomplished to cope with the above-described problem. That is, an object of the disclosure is to provide a driving assistance device for a vehicle, a driving assistance method for a vehicle, and a program capable of reducing troublesomeness that a driver feels when a display object present outside a vehicle is erroneously detected (including when display content of a display object is erroneously recognized) or when there is a high possibility that the display object is erroneously detected.

A first aspect of the disclosure relates to a driving assistance device for a vehicle including a camera sensor (front camera) and a controller (driving assistance ECU). The camera sensor (front camera) is configured to image scenery forward of a vehicle to generate image data. The controller (driving assistance ECU) is configured to, when determination is made that a specific display object is present forward of the vehicle based on the generated image data, recognize display content of the specific display object determined to be present and execute driving assistance control that is control for assisting driving by a driver of the vehicle corresponding to the display content of the specific display object. The controller (driving assistance ECU) is configured to execute, as the driving assistance control, control where an assistance level representing a degree of influence on the driver is low when determination is made that a rate of coincidence of recognition results that is a proportion of “the number of times in which the recognition results of the display content of the same specific display object are identical” to “the number of times of determination that the same specific display object is present” is less than a first threshold value, compared to when determination is made that the rate of coincidence of the recognition results is equal to or greater than the first threshold value.

In the first aspect of the disclosure, the driving assistance device may further include a notification device (display device and sound output device) configured to notify the driver of information regarding the specific display object. The controller (driving assistance ECU) may be configured to execute, as the driving assistance control, control including notification control for, with the notification device (display device and sound output device), notifying the driver that determination is made that the specific display object is present and adaptation control that is vehicle control for making a traveling state of the vehicle approach a state adapted to the display content of the specific display object when determination is made that the rate of coincidence of the recognition results is equal to or greater than the first threshold value, and execute, as the driving assistance control, control including the notification control while not including the adaptation control when determination is made that the rate of coincidence of the recognition results is less than the first threshold value.

In the first aspect of the disclosure, the controller (driving assistance ECU) may be configured to execute, as the driving assistance control, control where the assistance level is low when determination is made that the number of times of determination that the same specific display object is present is equal to or greater than a predetermined number of times while the rate of coincidence of the recognition results is less than a second threshold value, compared to when determination is made that the number of times of determination that the same specific display object is present is equal to or greater than the predetermined number of times and the rate of coincidence of the recognition results is equal to or greater than the second threshold value.

In the first aspect of the disclosure, the driving assistance device may further include a notification device (display device and sound output device) configured to notify the driver of information regarding the specific display object. The controller (driving assistance ECU) may be configured to execute, as the driving assistance control, control including notification control for, with the notification device (display device and sound output device), notifying the driver that determination is made that the specific display object is present and adaptation control that is vehicle control for making a traveling state of the vehicle approach a state adapted to the display content of the specific display object when the number of times of determination that the same specific display object is present is equal to or greater than the predetermined number of times and the rate of coincidence of the recognition results is equal to or greater than the second threshold value, and execute, as the driving assistance control, control including the notification control while not including the adaptation control when determination is made that the number of times of determination that the same specific display object is present is equal to or greater than the predetermined number of times while the rate of coincidence of the recognition results is less than the second threshold value.

In the first aspect of the disclosure, the controller (driving assistance ECU) may be configured to execute, as the driving assistance control, control where the assistance level is low when the number of times of determination that the same specific display object is present is less than the predetermined number of times, compared to when the rate of coincidence of the recognition results is equal to or greater than the first threshold value.

In the first aspect of the disclosure, the controller (driving assistance ECU) may be configured to execute, as the driving assistance control, control including notification control while not including adaptation control when the number of times of determination that the same specific display object is present is less than the predetermined number of times.

According to the aspect of the disclosure, the assistance level of the driving assistance control is changed (the content of the driving assistance control is changed) depending on the accuracy of recognition of the display content of the specific display object. Specifically, the level of the driving assistance control is set to be low when the recognition accuracy of the display content of the specific display object is low (that is, when there is a high possibility that the display content of the specific display object is erroneously recognized), compared to when the recognition accuracy is high. According to such a configuration, it is possible to reduce troublesomeness that the driver feels with the driving assistance control when the display content of the specific display object is erroneously recognized.

In the first aspect of the disclosure, the driving assistance device may further include a database (detection object DB) in which a position of the specific display object determined to be present by the controller (driving assistance ECU) and histories of the recognition results of the display content is registered. The controller (driving assistance ECU) may be configured to register the position of the specific display object determined to be present and the recognition results of the display content in the database (detection object DB) and calculate the rate of coincidence of the recognition results on the same specific display object with reference to the database (detection object DB).

The recognition results on the detected display object are registered in the database (detection object DB), whereby it is possible to achieve improvement of the accuracy of the database. According to the configuration in which the driving assistance device includes the database (detection object DB), a communication expense in referring to the database (detection object DB) does not occur.

In the first aspect of the disclosure, the controller (driving assistance ECU) may be configured to delete the recognition results on the same specific display object from the database (detection object DB) while leaving one recognition result when the number of times of determination that the same specific display object is present is equal to or greater than a predetermined number of times and the rate of coincidence of the recognition results is equal to or greater than a second threshold value.

In the first aspect of the disclosure, the controller (driving assistance ECU) may be configured to delete the recognition results on the specific display object not detected over a predetermined period, from the database (detection object DB).

According to such a configuration, it is possible to reduce the capacity of the database (detection object DB).

In the first aspect of the disclosure, the controller (driving assistance ECU) may be configured to calculate a similarity of the image data and a template prepared in advance for determining the presence of the specific display object, determine that the specific display object is present when the similarity is equal to or greater than a detection threshold value, and not register the recognition results on the specific display object in the database (detection object DB) when the similarity is equal to or greater than the detection threshold value while being less than an accuracy threshold value greater than the detection threshold value.

According to such a configuration, it is possible to restrain or suppress degradation of the accuracy of the recognition results registered in the database.

In the first aspect of the disclosure, the controller (driving assistance ECU) may be configured to delete the recognition results on the same specific display object from the database (detection object DB) when the number of times of determination that the same specific display object is present is equal to or greater than a predetermined number of times, the rate of coincidence of the recognition results is equal to or greater than a second threshold value, and similarity on the same specific display object is equal to or greater than a predetermined threshold value.

According to such a configuration, it is possible to reduce the capacity of the database (detection object DB).

A second aspect of the disclosure relates to a driving assistance method for a vehicle including determining whether or not a specific display object is present forward of a vehicle based on image data acquired by imaging scenery forward of the vehicle, when determination is made that the specific display object is present forward of the vehicle, recognizing display content of the specific display object determined to be present and executing driving assistance control that is control for assisting driving by a driver of the vehicle corresponding to the display content of the specific display object, and when determination is made that the specific display object is present forward of the vehicle, determining whether or not a rate of coincidence of recognition results that is a proportion of “the number of times in which the recognition results of the display content of the same specific display object are identical” to “the number of times of determination that the same specific display object is present” is less than a first threshold value. In the executing of the driving assistance control, control where an assistance level representing a degree of influence on the driver is low is executed as the driving assistance control when determination is made that the rate of coincidence of the recognition results is less than the first threshold value, compared to when determination is made that the rate of coincidence of the recognition results is equal to or greater than the first threshold value.

A third aspect of the disclosure relates to a program causing a computer of a driving assistance device for a vehicle to execute determining whether or not a specific display object is present forward of a vehicle based on image data acquired by imaging scenery forward of the vehicle, when determination is made that the specific display object is present forward of the vehicle, recognizing display content of the specific display object determined to be present and executing driving assistance control that is control for assisting driving by a driver of the vehicle corresponding to the display content of the specific display object, and when determination is made that the specific display object is present forward of the vehicle, determining whether or not a rate of coincidence of recognition results that is a proportion of “the number of times in which the recognition results of the display content of the same specific display object are identical” to “the number of times of determination that the same specific display object is present” is less than a first threshold value. In the executing of the driving assistance control, control where an assistance level representing a degree of influence on the driver is low is executed as the driving assistance control when determination is made that the rate of coincidence of the recognition results is less than the first threshold value, compared to when determination is made that the rate of coincidence of the recognition results is equal to or greater than the first threshold value.

According to the aspects of the disclosure, it is possible to reduce troublesomeness that the driver feels with the driving assistance control when the display content of the specific display object is erroneously recognized.

In the above description, to facilitate understanding of the disclosure, the components of the disclosure corresponding to those of an embodiment described below are accompanied by parenthesized names and/or reference signs that are used in the embodiment. However, the components of the disclosure are not limited to those in the embodiment defined by the names and/or reference signs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a vehicle;

FIG. 2 is a diagram showing content of a database (detection object DB) of display objects; and

FIG. 3 is a flowchart showing a driving assistance control start routine.

### DETAILED DESCRIPTION OF EMBODIMENTS

Hereinafter, a driving assistance device for a vehicle according to an embodiment of the disclosure will be described. In the following description, the driving assistance device for a vehicle may be abbreviated as an “assistance device”. The assistance device is mounted in a vehicle. In each embodiment described below, although a form in which the assistance device is mounted in a vehicle having an engine (internal combustion engine) as a drive power source for traveling is described, the assistance device can also be mounted in a vehicle (electrified vehicle) having a motor (electric motor) as a drive power source for traveling and a vehicle (hybrid vehicle) having an engine and a motor as a drive power source for traveling. A specific display object as a detection target of the assistance device includes characters, numerals, and symbols described on traffic signs provided at roadsides and above roads, electric notice boards, guide plates, and road surfaces. The specific display object also includes display objects where display content is not changed, and display objects (for example, display objects where video is displayed and display objects where display and non-display are switched) where display content is changed.

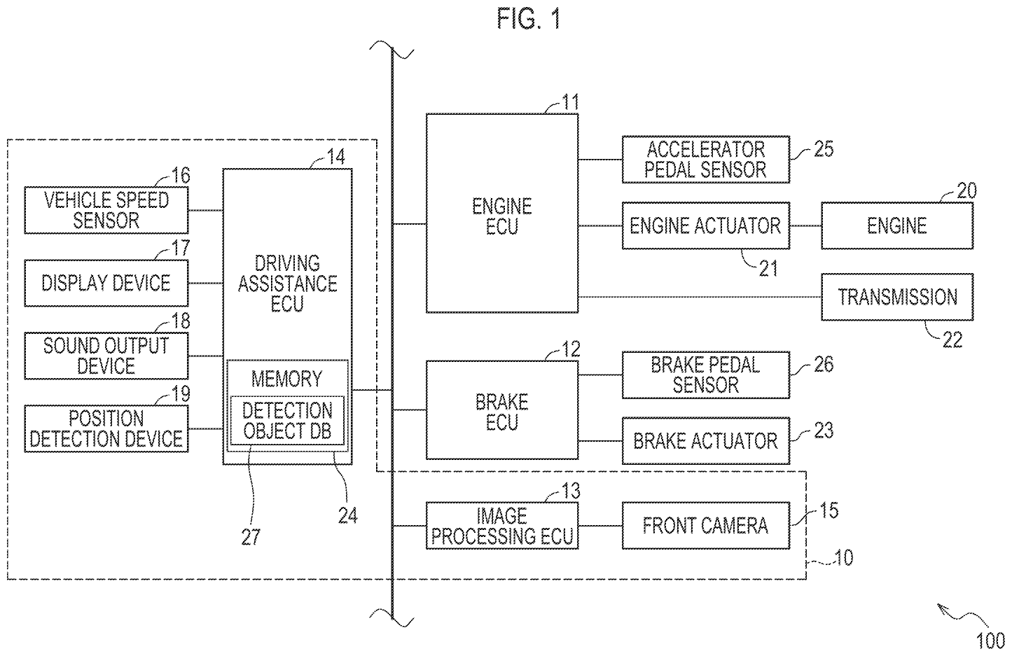

As shown in FIG. 1, a vehicle 100 has an assistance device 10, an engine ECU 11, and a brake ECU 12. The assistance device 10 has an image processing ECU 13, a driving assistance ECU 14, a front camera 15, a vehicle speed sensor 16, a display device 17, a sound output device 18, and a position detection device 19. Each ECU has a computer having a CPU and a memory, such as a ROM and a RAM. The CPU successively executes a predetermined program (routines) to perform reading of data, numerical operations, output of operation results, and the like. In the ROM, the program that is executed by the CPU, a look-up table (map), and the like are registered in advance. The RAM can temporarily store data. Such ECUs can perform data communication through a controller area network (CAN). In addition, the vehicle 100 has an engine 20 that is a drive power source, an engine actuator 21 that controls the engine 20, a transmission 22 that adjusts drive power of the engine 20 and transmits the drive power to drive wheels, and a brake actuator 23 that gives braking force to each wheel.

The engine ECU 11 is connected to an accelerator pedal sensor 25, the engine actuator 21, and the transmission 22. The accelerator pedal sensor 25 is configured to successively detect an operation amount (depression amount) of an accelerator pedal. The accelerator pedal is operated by a driver to change drive power of the vehicle 100 by adjusting power generated by the engine 20. The engine ECU 11 successively acquires a detection result of the operation amount of the accelerator pedal by the accelerator pedal sensor 25 and executes control such that the engine 20 and the transmission 22 transmit drive power corresponding to the acquired detection result to the drive wheels of the vehicle 100. The engine ECU 11 controls the engine 20 and the transmission 22 based on a command transmitted from the driving assistance ECU 14. When a drive power change command is received from the driving assistance ECU 14, the engine ECU 11 executes control in response to the drive power change command such that the engine 20 and the transmission 22 increase or decrease drive power to be transmitted to the drive wheels. That is, the engine ECU 11 can increase or decrease a speed of the vehicle 100 in response to the drive power change command.

The brake ECU 12 is connected to the brake actuator 23. The brake actuator 23 adjusts hydraulic pressure of hydraulic oil of a frictional brake mechanism provided in each of the wheels and gives frictional braking force corresponding to the hydraulic pressure to each of the wheels. The brake ECU 12 decides a driver requested deceleration based on an operation amount of a brake pedal detected by a brake pedal sensor 26 and executes control on the brake actuator 23 such that the vehicle 100 reduces the speed at the driver requested deceleration. When a brake command is received from the driving assistance ECU 14, the brake ECU 12 controls the operation of the brake actuator 23 such that the vehicle 100 reduces the speed at a requested deceleration included in the brake command. That is, the brake ECU 12 can adjust braking force (hereinafter, referred to as “vehicle braking force”) to be applied to the vehicle to decrease the speed of the vehicle 100 by driving the brake actuator 23 in response to the brake command.

The front camera 15 images scenery in a predetermined range forward of the vehicle 100 successively (for example, in a 100 msec cycle), generates data (image data) of the captured image, and successively transmits the generated image data to the image processing ECU 13. The term “forward” in the embodiment includes not only a front direction of the vehicle 100 but also diagonally forward upper and lower sides and diagonally forward right and left sides. The front camera 15 is provided near a rear-view mirror in a vehicle cabin. Note that a position where the front camera 15 is provided is not particularly limited, and may be, for example, “a predetermined position outside the vehicle cabin of the vehicle 100”, such as a center portion of a front bumper or a front portion of a side mirror.

The image processing ECU 13 determines whether or not a specific display object set in advance as a detection target is present forward of the vehicle 100 by executing known image recognition processing on the image data successively transmitted from the front camera 15. In other words, the image processing ECU 13 detects the specific display object present forward of the vehicle 100. As the image recognition processing, a known method, such as pattern matching or Hough transform, can be applied. Specifically, the image processing ECU 13 executes known image processing, such as edge detection, on the image data acquired from the front camera 15 and extracts the contours of all objects included in the image. Then, determination is made whether or not a specific display object is present forward of the vehicle 100 by executing pattern matching processing on the image data subjected to the image processing using a plurality of templates prepared in advance for respective kinds of specific display objects to determine whether or not a specific display object set as a detection target is present.

More specifically, the image processing ECU 13 calculates a similarity (Sum of Squared Difference (SSD) or Sum of Absolute Difference (SAD)) of the image data generated by the front camera 15 and the templates. Then, the image processing ECU 13 determines that a specific display object corresponding to a template having the similarity equal to or greater than a predetermined threshold value (hereinafter, referred to as a “detection threshold value”) and having the highest value of the similarity is detected (exactly, determines that the specific display object corresponding to the template is included in the captured image).

Then, when determination is made that the specific display object as a detection target is present, the image processing ECU 13 recognizes display content of the specific display object. In particular, when the specific display object is a traffic sign indicating the maximum speed, the image processing ECU 13 recognizes the maximum speed indicated by the specific display object. For example, the display content of the specific display object is associated with the template. Then, the image processing ECU 13 can recognize the content of the detected specific display object by recognizing the template corresponding to the specific display object determined to be present.

The display device 17 is configured to display the image (including figure, character, and symbol) based on a display command from the driving assistance ECU 14. Then, the display device 17 can provide various kinds of information to the driver by displaying the image. In particular, the display device 17 can notify the driver of determination that the specific display object is present forward of the vehicle 100 (in other words, the presence of the specific display object) and the display content of the specific display object, that is, information regarding the specific display object by displaying the image indicating the display content of the specific display object determined to be present. The display device 17 has, for example, a liquid crystal display and is disposed at a position (for example, a center console in the vehicle cabin) where the driver can view the display content of the specific display object. The display device 17 can display, for example, a two-dimensional image in full colors and can be constituted using a liquid crystal display, an organic EL display, a plasma display, or the like. In the embodiment, the display device 17 is a center display that is disposed near the center of an instrument panel in a vehicle width direction. Note that the display device 17 is not limited to the center display.

The sound output device 18 is configured to output sound based on a sound generation command from the driving assistance ECU 14. Specifically, the sound output device 18 has an amplifier and a speaker (loudspeaker). The sound output device 18 can notify the driver of information regarding the specific display object by generating predetermined sound when determination is made that the specific display object is present.

The vehicle speed sensor 16 is configured to successively detect the speed of the vehicle 100 and successively output a signal representing the detected speed of the vehicle 100. The vehicle speed sensor 16 is configured to output a signal that is changed depending on the speed (that is, a vehicle speed) of the vehicle 100. The driving assistance ECU 14 is configured to acquire the vehicle speed based on the signal from the vehicle speed sensor 16. The vehicle speed sensor 16 may be a wheel speed sensor provided in each of four wheels in the vehicle 100.

The driving assistance ECU 14 executes driving assistance control that is control for assisting driving of the vehicle 100 by the driver corresponding to the display content of the specific display object when the image processing ECU 13 determines that the specific display object is present. The driving assistance control includes control (hereinafter, referred to as “notification control”) for notifying (alerting) the driver of determination that the specific display object is present and the content of the specific display object and control (hereinafter, referred to as “adaptation control”) that is control for making the vehicle 100 approach a traveling state adapted to the display content of the specific display object.

The notification control includes control for displaying the image indicating the display content of the specific display object determined to be present on the display device 17 and control for outputting predetermined sound (alert sound, sound announcement, or the like) from the sound output device 18. For example, when determination is made that a specific display object (for example, a traffic sign) indicating the maximum speed is present, the maximum speed indicated in the specific display object is displayed on the display device 17 and alert sound is generated from the sound output device 18. According to the notification control, it is possible to notify the driver of determination that the specific display object is present and the display content of the display object determined to be present. With this, it is possible to prompt the driver to perform “a driving operation to make the traveling state of the vehicle 100 approach the traveling state adapted to the display content of the specific display object”.

The adaptation control is vehicle control for making the traveling state of the vehicle 100 approach the display content of the specific display object or coincide with the traveling state adapted to the display content. For example, the adaptation control is control for automatically reducing the speed of the vehicle 100 by adjusting vehicle drive power and/or vehicle braking force when the specific display object is a traffic sign (regulatory sign) indicating the maximum speed, and the speed of the vehicle 100 is higher than the maximum speed displayed in the specific display object.

The driving assistance ECU 14 can execute driving assistance control with different assistance levels. The assistance level is a degree of intervention in a driving operation of the driver (strength of a degree of influence on the traveling state of the vehicle 100). The higher the degree of intervention in the driving operation, the higher the assistance level. For example, when the driving assistance control is the notification control, the more easily the driver recognizes the notification (alert), the higher the assistance level.

Specifically, in an operation to display an image on the display device 17, the assistance level is set to be higher to processing of displaying video (also including image blinking and image magnification and reduction) than an operation to display a static image. In an operation to display video on the display device 17, the assistance level is set to be higher to faster or larger image motion (faster blinking speed and magnification and reduction speed). When the notification control is an operation to generate alert sound from the sound output device 18, the assistance level is higher as a volume level of the alert sound is greater. When the driving assistance control is the notification control, the assistance level is set to be higher to a combination of the processing of displaying the image on the display device 17 and the operation to generate the alert sound from the sound output device 18 than any one thereof. When the driving assistance control is the adaptation control, the greater a controlled variable, the higher the assistance level. For example, when the speed of the vehicle 100 is reduced, the greater a speed reduction width, the higher the assistance level. The assistance level is set to be higher to a combination of the notification control and the adaptation control than the notification control alone. In this way, when the assistance level is different, the content of the driving assistance control is different.

Then, the driving assistance ECU 14 (assistance device 10) executes first-level driving assistance control, second-level driving assistance control, and third-level driving assistance control depending on situations. The first-level driving assistance control among the three kinds of driving assistance control has the lowest degree of intervention in the driving operation of the driver, the third-level driving assistance control has the highest degree of intervention in the driving operation of the driver, and the degree of intervention in the driving operation of the second-level driving assistance control is between the degree of intervention in the driving operation of the first-level driving assistance control and the degree of intervention in the driving operation of the second-level driving assistance control.

More specifically, the driving assistance ECU 14 executes, as the first-level driving assistance control, the notification control for displaying the content of the specific display object on the display device 17. The driving assistance ECU 14 executes, as the second-level driving assistance control, the notification control for displaying the content of the specific display object on the display device 17 and outputting the alert sound from the sound output device 18. The driving assistance ECU 14 executes the notification control for displaying the content of the specific display object on the display device 17 and outputting the alert sound from the sound output device 18 and permits the execution of the adaptation control for reducing the speed of the vehicle 100 as the third-level driving assistance control. That is, in the embodiment, solely the notification control is executed at the lowest first level and the second-lowest second level, and the execution of the adaptation control is permitted in addition to the execution of the notification control at the highest third level. In this way, the content of the driving assistance control is different at the first level, the second level, and the third level.

Then, in the embodiment, the driving assistance ECU 14 changes the assistance level of the driving assistance control (the content of the driving assistance control) depending on a rate of coincidence of recognition results in the past on the specific display object determined to be present (that is, a rate of coincidence of recognition results on the same specific display object). That is, the image processing ECU 13 may erroneously recognize the display content of the specific display object due to a factor, such as staining of the specific display object, a state of a ray of light, or weather (rainfall, snowfall, and snow coverage). For this reason, while the same recognition result should be obtained every time on the same specific display object, the recognition result may be different (that is, erroneously recognized) due to the above-described factor. Then, when the image processing ECU 13 erroneously recognizes the display content of the specific display object, the driving assistance ECU 14 executes the driving assistance control based on the erroneously recognized display content. For example, when the display content (that is, the maximum speed) of the specific display object indicating the maximum speed is erroneously recognized, the driving assistance ECU 14 displays the erroneously recognized maximum speed on the display device 17 and generates alert sound from the sound output device 18. When the speed of the vehicle 100 detected by the vehicle speed sensor 16 is higher than the erroneously recognized maximum speed, the driving assistance ECU 14 may execute control for reducing the speed of the vehicle 100. For this reason, even though the speed of the vehicle 100 is equal to or lower than the maximum speed indicated in the specific display object, driving assistance control not adapted to the display content of the specific display object may be executed due to erroneous recognition. As a result, there is a concern that the driver feels troublesomeness in the driving assistance control.

Accordingly, in the embodiment, when determination is made that there is a high possibility that the display content of the specific display object is erroneously recognized, the assistance level of the driving assistance control is set to be low, compared to when determination is made that the display content of the specific display object is correctly recognized. Specifically, when the same specific display object is detected, the driving assistance ECU 14 refers to previous recognition results of the same specific display object and calculates a rate of coincidence of the recognition results of the same specific display object. “The rate of coincidence of the recognition results” is indicated by (the rate of coincidence of the recognition results)=(the number of times in which the recognition results of the display content of the same specific display object are identical)/(the number of times of determination that the same specific display object is present (in other words, the number of detection times of the same specific display object)). “The number of times of determination that the same specific display object is present” in the above-described expression is equal to or greater than two (that is, a plural number). That is, when the same specific display object is detected multiple times, the same specific display object tends to be more likely to be correctly recognized as the rate of coincidence of the recognition results is higher and to be more likely to be erroneously recognized as the rate of coincidence of the recognition results is lower. Accordingly, it is considered that, when determination is made that the same specific display object is present multiple times, and the rate of coincidence of the recognition results on the same specific display object is equal to or greater than a predetermined threshold value, the display content of the same specific display object can be correctly recognized, and when the rate of coincidence of the recognition results is less than the predetermined threshold value (first threshold value X₁), there is a high possibility that the display content of the same specific display object is erroneously recognized. Then, when the rate of coincidence of the recognition result is less than the predetermined threshold value, the assistance level of the driving assistance control is set to be low, compared to when the rate of coincidence of the recognition result is equal to or greater than the predetermined threshold value.

When the specific display object indicating the maximum speed is detected, a different maximum speed may be recognized due to erroneous recognition, and in this case, (the rate of coincidence of the recognition results) is present for each different maximum speed. For example, when one specific display object indicating the maximum speed of 80 km/h is detected ten times, in a case where the maximum speed is recognized as 80 km/h eight times among ten times and is recognized as 60 km/h two times, the rate of coincidence of the recognition results of the same specific display object is 0.8 on 80 km/h and is 0.2 on 60 km/h. In such a case, the rate of coincidence of the recognition results on the maximum speed on which “the rate of coincidence of the recognition result” is the highest is handled as “the rate of coincidence of the recognition results of the same specific display object”. In the above-described example, the higher value “0.8” is handled as the rate of coincidence of the recognition results of the same specific display object, and determination is made that the maximum speed indicated by the display object is 80 km/h.

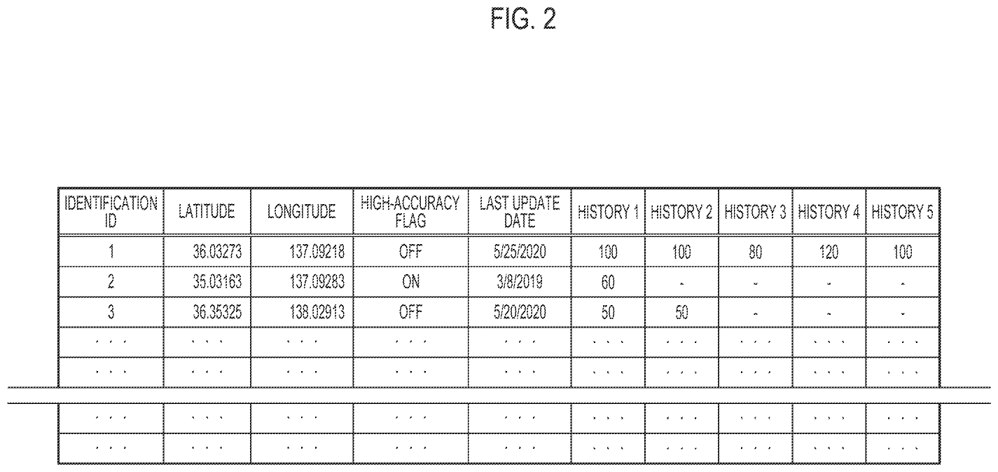

To realize such driving assistance control, a detection object DB 27 (database) shown in FIG. 2 is stored in a memory 24 of the driving assistance ECU 14 in a computer-readable format. In rows of “latitude” and “longitude” of the detection object DB 27, a position (longitude and latitude) of a specific display object determined to be present is registered. In a row of “high-accuracy flag”, a value indicating whether or not each specific display object is “likely to be correctly recognized” is registered. That is, the value of the row of “high-accuracy flag” is set to “ON” when the specific display object is likely to be correctly recognized, and is set to “OFF” when the specific display object is likely to be erroneously recognized. An initial value of the high-accuracy flag is set to “OFF”. That is, a high-accuracy flag on a specific display object (a specific display object on which the number of times of determination to be present is once) determined to be present first is “OFF”. In a row of “history”, recognition results of display content of a specific display object are registered. The example shown in FIG. 2 shows an example where a specific display object is a traffic sign (regulatory sign) indicating the maximum speed, and in this case, recognition results of the maximum speed are registered in the row of the history. In FIG. 2, although a configuration in which previous recognition results for five times in the past are registered is shown, the number of times of recognition results to be registered in the detection object DB 27 is not limited to five. In a row of “last update date”, a last date on which the high-accuracy flag on each display object is changed between ON and OFF or the content of the row of “history” is changed is registered.

In a case where a specific display object is detected by the image processing ECU 13, the driving assistance ECU 14 searches whether or not a previous recognition history on the detected specific display object is present. Then, when the recognition history on the detected specific display object is present, the driving assistance ECU 14 determines whether or not a rate of coincidence of a present recognition result and recognition results for multiple times in the past of display content on the detected specific display object (that is, the same specific display object) is equal to or greater than the first threshold value X₁. When the rate of coincidence of the recognition results is equal to or greater than the first threshold value X₁, it can be considered that there is a high possibility that the display content of the same specific display object is accurately recognized. On the other hand, when the rate of coincidence of the recognition result is less than the first threshold value X₁, it can be considered that there is a possibility that the display content of the same specific display object is erroneously recognized. Accordingly, the driving assistance ECU 14 executes driving assistance control with a low assistance level when the rate of coincidence of the recognition results is less than the first threshold value X₁, compared to when the rate of coincidence of the recognition results is equal to or greater than the first threshold value X₁. According to such a configuration, it is possible to reduce troublesomeness that the driver feels with the driving assistance control when the display content of the specific display object is erroneously recognized. A specific value of the first threshold value X₁ is not particularly limited and can be suitably set.

The driving assistance ECU 14 uses a position of the vehicle 100 detected by the position detection device 19 and the value of the row of the position of the detection object DB 27 for determination of identity of the detected specific display object and the display object registered in the detection object DB 27. Specifically, when a history of a display object at the same position as the position of the vehicle 100 detected by the position detection device 19 is registered in the detection object DB 27 at a timing at which the image processing ECU 13 determines that the specific display object is present, the driving assistance ECU 14 determines that “the specific display object determined to be present by the image processing ECU 13” is the same object as a detection object at the same position registered in the detection object DB. Note that, when an error of a GPS is taken into consideration, and there is no history of a display object at a position coinciding with the position of the vehicle 100 detected by the position detection device 19, the driving assistance ECU 14 determines that a display object closest to the position of the vehicle 100 detected by the position detection device 19 and at a predetermined distance or less from the position of the vehicle 100 detected by the position detection device 19 is the same display object as the specific display object determined to be present.

Then, the driving assistance ECU 14 updates the value of the row of “history” of the display object in the detection object DB 27 each time determination is made that the specific display object is present, and the recognition result of the display content of the specific display object is acquired from the image processing ECU 13. Note that, when there is a concern that the accuracy of the detection object DB 27 is degraded due to update, the driving assistance ECU 14 executes the driving assistance control while not updating the detection object DB 27. Alternatively, the driving assistance ECU 14 updates the detection object DB 27 (specifically, the value of each row on the specific display object determined to be present is added to the detection object DB 27) while not changing the last update date.

For example, when the image processing ECU 13 determines that the specific display object is present, a probability that the specific display object determined to be present and the display object registered in the detection object DB 27 are identical decreases as a distance between the position of the vehicle 100 detected by the position detection device 19 and the position registered in the detection object DB 27 increases. Accordingly, “another predetermined distance” smaller than the “predetermined distance” is set, and when the distance between “the position of the vehicle 100 detected by the position detection device 19” and “the position of the display object registered in the detection object DB 27” is equal to or greater than the “other predetermined distance” and equal to or smaller than the “predetermined distance”, it is considered that there is a possibility that the specific display object determined to be present and the display object registered in the detection object DB 27 are different display objects. Then, in this case, the driving assistance ECU 14 executes the driving assistance control while not updating the detection object DB 27.

When pattern matching is used for determination about whether or not the specific display object is present, the image processing ECU 13 calculates a similarity of a template and a captured image, and when the similarity is equal to or greater than a detection threshold value, determines that the specific display object is present. In this case, an accuracy threshold value that is value higher than the detection threshold value is set, and when the similarity is equal to or greater than the detection threshold value and is less than the accuracy threshold value, it is considered that the accuracy of recognition of the display content of the specific display object is low. Accordingly, in this case, the image processing ECU 13 does not update the history on the specific display object.

In a case where the number of times of determination to be present on the same specific display object in the past is small, the reliability of the rate of coincidence of the recognition results on the same specific display object decreases. Accordingly, when determination is made that the same specific display object is present, the driving assistance ECU 14 determines “the number of times of determination that the same specific display object is present” in the past including the present determination on the same specific display object. “The number of times of determination that the same specific display object is present” is the number of times including the present determination. Hereinafter, the number of times is referred to as “the number of detection times”. Then, when the number of detection times in the past on the same specific display object is equal to or greater than a predetermined number of times, while the rate of coincidence of the recognition results in the past on the same specific display object (the rate of coincidence of the recognition results calculated including the present recognition result) is less than a second threshold value X₂, the assistance level of the driving assistance control is set to be low, compared to when the number of detection times in the past on the same specific display object is equal to or greater than the predetermined number of times, and the rate of coincidence of the recognition results in the past on the same specific display object is equal to or greater than the second threshold value X₂. That is, in a case where the number of detection times in the past is equal to or greater than the predetermined number of times, it can be considered that the reliability of the rate of coincidence of the recognition results in the past is high, and in a case where the number of detection times in the past is less than the predetermined number of times, it can be considered that the reliability of the rate of coincidence of the recognition results in the past is low.

Then, with determination of the rate of coincidence of the recognition results in the past when the number of detection times in the past is equal to or greater than the predetermined number of times, when it is considered that there is a high possibility that the display content of the same specific display object is correctly recognized, it is possible to provide driving assistance control conforming to the display content of the same specific display object. The second threshold value X₂ is a value higher than the first threshold value X₁. Note that a specific value of the second threshold value X₂ is not limited and is suitably set. Similarly, a specific value of “the predetermined number of times” is not limited and is suitably set.

Then, when the number of detection times in the past on the same specific display object is equal to or greater than the predetermined number of times, while the rate of coincidence of the recognition results in the past on the same specific display object is less than the second threshold value X₂, it is considered that the same specific display object highly tends to be likely to be erroneously detected, compared to other cases. Accordingly, in this case, it is considered that there is a possibility of erroneous recognition, the assistance level of the driving assistance control is set to be low, compared to when “the number of detection times is less than the predetermined number of times” and when “the number of detection times is equal to or greater than the predetermined number of times and the rate of coincidence of the recognition results in the past is equal to or greater than the second threshold value X₂”. Specifically, the driving assistance ECU 14 sets the assistance level of the driving assistance control to the lowest first level.

When the number of detection times in the past of the same specific display object is less than the predetermined number of times, it is considered that the reliability of the rate of coincidence of the recognition results in the past is low as described above. Accordingly, in this case, the driving assistance ECU 14 sets the level of the driving assistance control to be low, compared to when the number of detection times in the past on the same specific display object is equal to or greater than the predetermined number of times, and the rate of coincidence of the recognition results in the past on the specific display object is equal to or greater than the second threshold value X₂. In the embodiment, the assistance level of the driving assistance control in this case is set to the second level. That is, the driving assistance ECU 14 sets the assistance level of the driving assistance control to be lower than the third level when the number of detection times in the past on the same specific display object is equal to or greater than the predetermined number of times, and the rate of coincidence of the recognition results in the past on the same specific display object is equal to or greater than the second threshold value X₂, and to be higher than the first level when the number of detection times in the past on the same specific display object is equal to or greater than the predetermined number of times, while the rate of coincidence of the recognition results in the past on the same specific display object is less than the second threshold value X₂.

In the embodiment, the driving assistance ECU 14 changes the assistance level of the driving assistance control depending on whether the high-accuracy flag is ON or OFF. Specifically, as described above, when the number of detection times in the past on any same specific display object is equal to or greater than the predetermined number of times, and the rate of coincidence of the recognition results in the past is equal to or greater than the second threshold value X₂, the driving assistance ECU 14 sets the high-accuracy flag of the same specific display object to ON. On the other hand, when the number of detection times in the past on any same specific display object is equal to or greater than the predetermined number of times, while the rate of coincidence of the recognition results in the past on the same specific display object is less than the first threshold value X₁, the driving assistance ECU 14 sets the high-accuracy flag of the same specific display object to OFF. Then, the driving assistance ECU 14 sets the assistance level of the driving assistance control to be high when the high-accuracy flag is ON, compared to when the high-accuracy flag is OFF. Specifically, the driving assistance ECU 14 sets the assistance level of the driving assistance control to the third level when the high-accuracy flag is ON, and sets the assistance level of the driving assistance control to the first level or the second level when the high-accuracy flag is OFF. When the number of detection times in the past is less than the predetermined number of times, it is not possible to consider that the rate of coincidence of the recognition results in the past on the same specific display object is significant as an index indicating “whether or not the same specific display object likely to be correctly recognized”. Accordingly, the driving assistance ECU 14 sets the high-accuracy flag to OFF on the specific display object on which the number of detection times in the past is less than the predetermined number of times. The driving assistance ECU 14 sets the initial value of the high-accuracy flag to OFF.

Accordingly, when the high-accuracy flag on the same specific display object is OFF, and when the number of detection times in the past is equal to or greater than the predetermined number of times, and the rate of coincidence of the recognition results in the past is equal to or greater than the second threshold value X₂, the driving assistance ECU 14 changes the high-accuracy flag on the same specific display object from OFF to ON. Then, after the high-accuracy flag is changed to ON, the driving assistance ECU 14 maintains the high-accuracy flag to ON unless the rate of coincidence of the recognition results decreases to be less than the first threshold value X₁. Then, the driving assistance ECU 14 sets the assistance level of the driving assistance control to be high when the same specific display object is detected while the high-accuracy flag is ON, compared to when the high-accuracy flag is OFF. In the embodiment, the driving assistance ECU 14 executes the driving assistance control with the highest assistance level.

Incidentally, in a configuration in which the driving assistance ECU 14 has the detection object DB 27, the size of the detection object DB 27 increases as the number of specific display objects determined to be present and the number of times (that is, the number of detection times) of determination to be present increase. Then, as a result, a use amount of the memory 24 needed for storing the detection object DB increases. When the driving assistance ECU 14 has the detection object DB 27, that is, when the vehicle 100 has the detection object DB 27, there is a great restriction to the capacity of the memory 24, compared to a configuration in which the detection object DB 27 is registered in a memory 24 of equipment (for example, a data center) outside the vehicle, and thus, in some embodiments, the size of the detection object DB 27 is small.

Therefore, the driving assistance ECU 14 integrates histories of the specific display object, on which the high-accuracy flag is ON, into one history and deletes remaining histories. In regard to a display object where “identification ID” of FIG. 2 is “2”, a state in which histories are integrated into one history is shown. Specifically, the driving assistance ECU 14 deletes recognition histories of a specific display object, on which the number of detection times in the past is equal to or greater than the predetermined number of times, and the rate of coincidence of the recognition results in the past is equal to or greater than the second threshold value X₂, while leaving one history where the recognition result is correct (a value where the rate of coincidence of the recognition results is equal to or greater than the predetermined threshold value). With this, it is possible to reduce the use amount of the memory 24 of the driving assistance ECU 14 while maintaining the level of the recognition result using the detection object DB 27.

The driving assistance ECU 14 may delete the histories of the recognition results in the past of the same specific display object and may integrate the histories into one history when “the number of detection times in the past of the same specific display object is equal to or greater than the predetermined number of times, and the rate of coincidence of the recognition results in the past is equal to or greater than the second threshold value X₂”, instead of when the high-accuracy flag is ON. That is, the recognition result of the display content of the same specific display object should be the same recognition result every time, and thus, when the number of detection times in the past of the same specific display object is equal to or greater than the predetermined number of times (at least multiple times), and the rate of coincidence of the recognition results in the past is equal to or greater than the second threshold value X₂, it is considered that the display content of the same specific display object can be accurately recognized. Therefore, the driving assistance ECU 14 sets the high-accuracy flag on such a specific display object to ON and deletes the histories of recognition while leaving one history. With this, it is possible to achieve reduction in size of the detection object DB 27 while maintaining accuracy of a determination result using the detection object DB 27. Here, although the second threshold value X₂ is used for determination of a condition for deleting the histories of the recognition results in the past of the same specific display object and integrating the histories into one history, the first threshold value X₁ may be used. A threshold value different from the first threshold value X₁ and the second threshold value X₂ may be used.

When an elapsed period from the last update date of the history is equal to or longer than a predetermined number of days, there is a low possibility that the specific display object is detected later (the vehicle does not pass through a position where the specific display object is provided) or there is a high possibility that the specific display object is removed or replaced. Therefore, the driving assistance ECU 14 compares a current date with the last update date on each display object registered in the detection object DB 27 and deletes information on a specific display object with a lapse of the predetermined period from the last update date (that is, a specific display object not detected after the last update date). With this, it is possible to achieve reduction in size of the detection object DB 27, and to achieve improvement of the accuracy of the detection object DB 27. A specific value of the “predetermined period” is not particularly limited and can be suitably set.

When the recognition results in the past on the same specific display object do not coincide with a predetermined number of times or more, the histories of the recognition results on the same specific display object may be deleted from the detection object DB 27. For example, there is a case where a pattern on a vehicle traveling forward of a host vehicle (for example, a pattern on a rear surface of a loading platform of a truck) is detected (that is, is erroneously recognized) as a display object. In such a case, a present recognition result does not coincide with a past recognition result. Therefore, a recognition history is deleted in such a case, whereby it is possible to suppress execution of driving assistance control based on erroneous recognition. “The predetermined number of times” is not particularly limited and can be suitably set.

In the configuration in which the above-described high-accuracy flag is used, when the display content of the specific display object is changed, even though the high-accuracy flag is ON before change, the high-accuracy flag is changed to OFF after change. Then, the histories of the past recognition results are registered in the detection object DB 27, and until a sign is detected a certain number of times after the sign is changed, the rate of coincidence of the recognition results on the specific display object is less than a predetermined value (second threshold value X₂), and a period during which the assistance level of the driving assistance control is low (is set to the first level) when the specific display object is detected occurs. Therefore, to reduce the period of the first level in such a case, the past recognition results on the specific display object may be deleted from the detection object DB 27.

Specifically, when the number of detection times in the past on the same specific display object is equal to or greater than the predetermined number of times, and the rate of coincidence of the recognition results in the past is less than the second threshold value X₂, the driving assistance ECU 14 acquires the similarity on the same specific display object from the image processing ECU 13 and determines whether or not the similarity is equal to or greater than the accuracy threshold value. Then, when the similarity is equal to or greater than the accuracy threshold value, it is considered that the content of the same specific display object is correctly recognized by the image processing ECU 13. Then, the histories of the same specific display object are deleted excluding the latest time (that is, one time when the similarity is equal to or greater than the accuracy threshold value). For this reason, in this case, the number of detection times of the same specific display object is set to one. Accordingly, when the same specific display object is detected next time, “the number of detection times is less than the predetermined number of times”, and thus, the driving assistance ECU 14 set the assistance level of the driving assistance control to be high, compared to when the number of detection times on the same specific display object is equal to or greater than the predetermined number of times, while the rate of coincidence of the past recognition results is less than the second threshold value X₂. Therefore, it is possible to reduce a period of an assistance level of driving assistance control that is executed when the number of detection times in the past on the same specific display object is equal to or greater than the predetermined number of times, and the rate of coincidence of the past recognition results is less than the second threshold value X₂.

There is also a case where a specific display object is hidden by a heavy vehicle, such as a truck, traveling forward of the vehicle 100, and the specific display object is not detected by the image processing ECU 13. In this case, the driving assistance ECU 14 executes driving assistance control based on a history registered in the detection object DB 27. Specifically, when a specific display object is not detected by the image processing ECU 13 even though the vehicle 100 passes through a position where the specific display object registered in the detection object DB 27 is present, determination is made whether the high-accuracy flag on the specific display object registered in the detection object DB 27 is ON or OFF, and when the high-accuracy flag is OFF, determination is further made whether or not the rate of coincidence of the past recognition results is equal to or greater than the predetermined threshold value (second threshold value X₂). Then, when “the high-accuracy flag on the specific display object is ON” or when “the high-accuracy flag on the specific display object is OFF while the rate of coincidence of the past recognition results is equal to or greater than the predetermined threshold value (second threshold value)”, it is considered that the specific display object cannot be recognized due to any factor. Then, the driving assistance ECU 14 executes driving assistance control similarly to when the specific display object is detected. Note that, in this case, the driving assistance ECU 14 may reduce the assistance level of the driving assistance control, compared to when the specific display object is actually detected. “When the rate of coincidence of the recognition results exceeds the second threshold value X₂ even though the high-accuracy flag is not ON” corresponds to when the number of detection times is less than the predetermined number of times.

With this, even though a specific display object is hidden by another vehicle 100 or the like and is not detected, it is possible to provide driving assistance control adapted to the display content of the specific display object that should be present. In the embodiment, the driving assistance ECU 14 has the detection object DB 27. According to such a configuration, for example, communication with a detection object DB that is constructed outside the vehicle 100 may not be performed, and thus, even though a specific display object is not detected, it is possible to provide driving assistance control without needing a communication expense.

In addition, when the number of detection times in the past on the same specific display object is equal to or greater than the predetermined number of times, while the rate of coincidence of the recognition results in the past is not equal to or greater than the second threshold value X₂, it is considered that the same specific display object is hardly recognized with the image processing ECU 13 due to staining, an illumination condition, or the like. Therefore, in imaging such a display object, a configuration in which the rate of coincidence of the recognition results increases by increasing the magnification of the front camera 15 (achieving improvement of camera performance) can be applied.

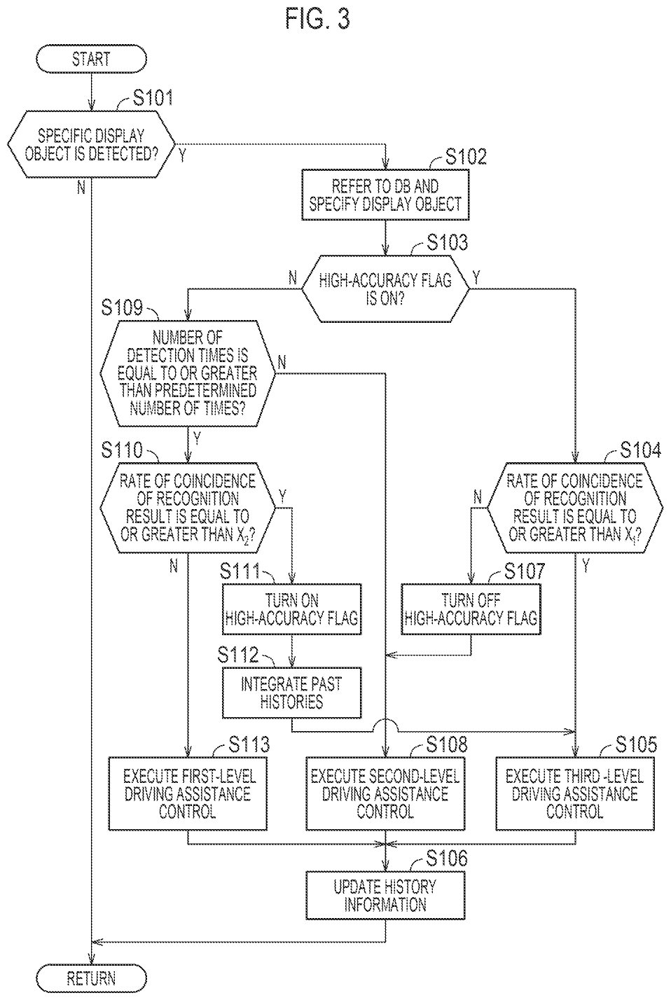

Next, a specific operation of the driving assistance ECU 14 will be described. The CPU (hereinafter, simply referred to as a “CPU”) of the driving assistance ECU 14 repeatedly executes a “driving assistance control start routine” shown in a flowchart of FIG. 3 each time a predetermined time elapses. When a specific display object is present forward of the vehicle 100, the CPU continues to determine that the specific display object is present until the vehicle 100 passes through the position of the specific display object. For this reason, the CPU successively tracks traces the specific display object detected once by a known object tracking method, thereby setting the number of times of determination that “the specific display object is present” to one in a period from when the specific display object is framed in the front camera 15 until the specific display object is framed out of the front camera 15. A computer program for executing the driving assistance control start routine is stored in the ROM of the driving assistance ECU 14 in advance. The CPU of the driving assistance ECU 14 reads the computer program from the ROM and executes the computer program. With this, the driving assistance control start routine is executed.

In Step S101, the CPU determines whether or not a specific display object as a detection target is present forward of the vehicle 100. When determination is made that the specific display object is not present forward of the vehicle 100, the CPU ends the driving assistance control start routine once. Accordingly, the driving assistance control is not started until determination is made that the specific display object is present. Note that the CPU may continue the driving assistance control when the driving assistance control is already executed.

When determination is made in Step S101 that the specific display object is present, the CPU progresses to Step S102. In Step S102, the CPU refers to the detection object DB 27, searches whether or not the specific display object determined to be present is registered in the detection object DB 27, and when the specific display object determined to be present is registered, determines a display object that is the same as the detected specific display object, among a plurality of display objects registered in the detection object DB 27. Specifically, the CPU acquires a detection result of a current position (longitude and latitude) of the vehicle 100 from the position detection device 19 and collates the detection result of the current position with the positions (longitude and latitude) of the display object registered in the detection object DB 27, thereby determining identity of the specific display object determined to be present and the display object registered in the detection object DB 27. The CPU recognizes the display content of the specific display object determined to be present. Then, the CPU progresses to Step S103.

There is a case where a display object at a position coinciding with the position detected by the position detection device 19 is not present in the detection object DB 27. In this case, the CPU determines that “a display object closest to the position of the vehicle 100 detected by the position detection device 19 and at a distance equal to or less than a predetermined value from the current position of the vehicle 100” among the display objects registered in the detection object DB 27 is the same specific display object as the specific display object determined to be present. When “a display object at a distance equal to or less than the predetermined value from the position of the vehicle 100 at a time when the specific display object is detected” is not present in the detection object DB 27, the CPU determines that the specific display object determined to be present is a display object determined to be present first at present. In this case, the CPU sets the number of detection times to “one” while setting the high-accuracy flag on the specific display object to “OFF”.

In Step S103, the CPU determines whether the high-accuracy flag on the specific display object determined to be present is ON or OFF. When the high-accuracy flag is ON, the CPU progresses to Step S104.

In Step S104, the CPU calculates the rate of coincidence (the rate of coincidence including the present recognition result) of the recognition results in the past of the specific display object with reference to the detection object DB 27 and determines whether or not the calculated rate of coincidence of the recognition results in the past is equal to or greater than the first threshold value X₁. When the rate of coincidence of the recognition results of the same specific display object is equal to or greater than the first threshold value X₁, the CPU progresses to Step S105. In Step S105, the CPU executes the third-level driving assistance control. Then, the CPU progresses to Step S106.

When determination is made in Step S104 that the rate of coincidence of the recognition results is less than the first threshold value X₁, the CPU progresses to Step S107. In Step S107, the CPU changes the value of the high-accuracy flag on the same specific display object from ON to OFF. Then, the CPU progresses to Step S108. In Step S108, the CPU executes the second-level driving assistance control. Then, the CPU progresses to Step S106.

In Step S106, the CPU adds a recognition result of the specific display object determined to be present in Step S101 to the detection object DB 27, and updates the last update date on the specific display object registered in the detection object DB 27. When progressing to Step S106 through Step S107, the CPU changes the value of the high-accuracy flag on the specific display object registered in the detection object DB 27 from ON to OFF.

In this way, in the driving assistance control start routine, the CPU sets the assistance level of the driving assistance control to be low when the rate of coincidence of the recognition results is less than the first threshold value X₁, compared to when the rate of coincidence of the recognition results is equal to or greater than the first threshold value X₁. That is, when driving assistance control is executed based on display content erroneously recognized on the specific display object, the driver may feel a sense of discomfort with the driving assistance control or may feel troublesomeness in the driving assistance control. Therefore, when the high-accuracy flag on the specific display object determined to be present is ON, and the rate of coincidence of the recognition results is equal to or greater than the first threshold value X₁, it is considered that there is a high possibility that the display content of the specific display object is correctly recognized (is not erroneously recognized). Then, in this case, the CPU executes the third-level driving assistance control with the highest assistance level. In contrast, even though the high-accuracy flag is ON, when the rate of coincidence of the recognition results is less than the first threshold value X₁, the CPU changes the high-accuracy flag to OFF, and executes the second-level driving assistance control lower than the third level.

According to the driving assistance control start routine, when the display content of the specific display object is correctly recognized, it is possible to execute driving assistance control adapted to the display content of the specific display object. On the other hand, it is possible to reduce a sense of discomfort or troublesomeness that the driver feels with the driving assistance control when the display content of the specific display object is erroneously recognized.

In Step S103, when the high-accuracy flag is OFF, the CPU progresses to Step S109. In Step S109, the CPU determines whether or not the number of detection times of the same specific display object determined to be present in Step S101 is equal to or greater than a threshold value. When the number of detection times is equal to or greater than the threshold value, the CPU progresses to Step S110.

In Step S110, the CPU determines whether or not the rate of coincidence of the recognition results in the past on the same specific display object is equal to or greater than the second threshold value X₂. When determination is made that the rate of coincidence of the recognition results in the past is equal to or greater than the second threshold value X₂, the CPU progresses to Step S111.

When the number of detection times of the same specific display object is equal to or greater than the predetermined number of times, and the rate of coincidence of the recognition results on the same specific display object is equal to or greater than the second threshold value X₂, the same specific display object tends to be likely to be correctly recognized by the image processing ECU 13. Therefore, in Step S111, the CPU changes the high-accuracy flag on the same specific display object from OFF to ON. Then, the CPU progresses to Step S112. In Step S112, the CPU integrates the past histories on the same specific display object. Then, the CPU progresses to Step S105, and executes the third-level driving assistance control.

When determination is made in Step S110 that the rate of coincidence of the recognition results of the specific display object is less than the second threshold value X₂, the CPU progresses to Step S113. In Step S113, the CPU executes the first-level driving assistance control. Then, the CPU progresses to Step S106.

In Step S106, the CPU registers the recognition result on the specific display object determined to be present in Step S101 in the detection object DB 27, and changes the last update date registered in the detection object DB 27 to a date on which the specific display object is detected.

In this way, in the driving assistance control start routine, the CPU sets the assistance level of the driving assistance control to be high when the rate of coincidence of the recognition results on the same specific display object is equal to or greater than the second threshold value X₂, compared to when the rate of coincidence of the recognition results is equal to or less than the second threshold value X₂. With this, when the display content of the specific display object is correctly recognized, it is possible to execute driving assistance control adapted to the display content of the specific display object. Specifically, when the rate of coincidence of the recognition results on the same specific display object is equal to or greater than the second threshold value X₂, the CPU executes the third-level driving assistance control with the highest assistance level. On the other hand, the CPU sets the assistance level of the driving assistance control to be low when the rate of coincidence of the recognition results on the same specific display object is less than the second threshold value X₂, compared when the rate of coincidence of the recognition results is equal to or greater than the second threshold value X₂. In particular, when the number of detection times on the same specific display object is less than the predetermined number of times, and the rate of coincidence of the recognition results on the same specific display object is less than the second threshold value X₂, the CPU executes the first-level driving assistance control with the lowest assistance level. With this, it is possible to reduce troublesomeness or a sense of discomfort that the driver feels with the driving assistance control when the display content of the same specific display object is erroneously recognized.

When the number of detection times of the same specific display object is small, the reliability of the rate of coincidence of the recognition results on the same specific display object as an index indicating whether or not “the same specific display object is correctly recognized” is low. Therefore, in Step S109, the CPU determines whether or not the number of detection times on the specific display object determined to be present in Step S101 is equal to or greater than the predetermined number of times, and when the number of detection times is less than the predetermined number of times, progresses to Step S108. That is, in this case, the CPU sets the assistance level to be lower than the third level that is the assistance level when the high-accuracy flag is ON, and sets the assistance level to be higher than the first level that is the assistance level when the rate of coincidence of the recognition results is less than the second threshold value X₂. When history data of a specific display object is not present in the detection object DB 27, that is, when the specific display object is a display object detected first, similarly to when the high-accuracy flag is OFF and the number of detection times is equal to or less than the predetermined number of times, the CPU progresses from Step S102 to Step S108, and executes the second-level driving assistance control.

When a specific display object is detected, the CPU updates the detection history of the specific display object in the detection object DB 27; however, when there is a concern that the accuracy of the detection object DB 27 is degraded due to update, a routine where the detection object DB 27 is not updated is applied. For example, at least one of when the similarity calculated at the time of image recognition by the image processing ECU 13 is less than the accuracy threshold value and when the distance between the specific display object determined to be present and the display object registered in the detection object DB 27 is equal to or greater than the predetermined distance, the CPU executes the driving assistance control while not updating the detection object DB 27. According to such a configuration, it is possible to restrain or suppress degradation of the accuracy of the detection object DB.

As described above, when the display content of the specific display object is changed, a period during which the assistance level of the driving assistance control is low occurs. To reduce the period, a step of determining whether nor not the similarity calculated for detection of the specific display object by the image processing ECU 13 is equal to or greater than the accuracy threshold value may be added between Step S110 and Step S113. Then, in the added step, when determination is made that the similarity is equal to or greater than the accuracy threshold value, the CPU deletes the recognition results (histories) of the specific display object. On the other hand, in the added step, when determination is made that the similarity is less than the accuracy threshold value, the CPU does not delete the recognition results of the specific display object. According to such a driving assistance control start routine, when the number of detection times of the same specific display object is equal to or greater than the predetermined number of times (in Step S109, “Y”), the rate of coincidence of the recognition results in the past on the same specific display object is less than the second threshold value X₂ (in Step S110, “N”), and the similarity on the same specific display object is equal to or greater than the predetermined threshold value, the recognition results of the same specific display object are deleted from the detection object DB 27. Accordingly, it is possible to reduce a period during which the assistance level of the driving assistance control is low.

### Other Embodiments

In the above-described embodiment, although a configuration in which the driving assistance ECU 14 has the detection object DB 27 has been described, a configuration may be made in which the detection object DB 27 is constructed outside the vehicle 100 or a detection object DB is constructed in a data center of the vehicle 100. In this case, a configuration may be made in which the driving assistance ECU 14 can refer to the detection object DB of the data center through wireless communication between the assistance device 10 of the vehicle 100 and the data center, and the detection object DB of the data center is updated by transmitting the recognition result by the driving assistance ECU 14 to the data center. According to such a configuration, a detection object DB by detection results of other vehicles can be shared, and thus, for example, history information and a high-accuracy flag of a specific display object detected first by the vehicle 100 can be used.

A configuration may be made in which, when the elapsed period from the last update date on the detected specific display object is equal to or longer than the predetermined number of days, it is considered that the reliability of the history on the specific display object is low, and the assistance device 10 performs communication with the data center to refer to the detection object DB of the data center. Then, when the last update date on the specific display object registered in the detection object DB of the data center is more recent than the last update date registered in the detection object DB 27 of the driving assistance ECU 14 of the vehicle 100, driving assistance control is executed using information registered in the detection object DB of the data center. According to such a configuration, it is possible to achieve improvement of the accuracy of setting of the assistance level of the driving assistance control, compared to a configuration in which solely the detection object DB 27 of the driving assistance ECU 14 of the vehicle 100 is used.

A configuration may be made in which the assistance device 10 refers to the detection object DB 27 when the detected specific display object is registered in the detection object DB 27 of the driving assistance ECU 14, and performs communication with the data center to refer to the detection object DB of the data center when the detected specific display object is not registered in the detection object DB 27. A configuration may be made in which, when the elapsed period from the last update date of the detected specific display object is equal to or longer than a predetermined period, the assistance device 10 performs communication with the data center to refer to the detection object DB of the data center. That is, a configuration may be made in which, when it is considered that the accuracy (reliability) of the detection object DB 27 of the driving assistance ECU 14 of the vehicle 100 is low, the assistance device 10 performs communication with the data center to refer to the detection object DB 27 of the data center. According to such a configuration, driving assistance control with high accuracy can be provided while a communication expense is suppressed.

Although the embodiments of the disclosure have been described, the disclosure is not limited to the above-described embodiments, and following embodiments are also included in the technical scope of the disclosure. In addition to the following embodiments, the disclosure can be embodied in various modified forms without departing from the spirit of the disclosure.

For example, in the above-described embodiment, although the sign indicating the maximum speed has been described as a display object to be detected, a display object to be detected is not limited. For example, as the display object to be detected, various traffic signs, such as a sign for prohibition of forward movement in a direction other than a designated direction, a stop sign, and a minimum speed sign, can be applied. As the display object to be detected, in addition to the traffic signs, electric notice boards and various kinds of guide display can be applied.

The above-described first-level, second-level, and third-level driving assistance control are examples, and the disclosure is not limited thereto. For example, the driving assistance control may be control described below.

### EXAMPLE 1 OF COMBINATION

First Level: The CPU executes notification control for displaying a static image of a detected specific display object on the display device 17.

Second Level: The CPU executes notification control for displaying video of the specific display object (for example, a screen on which the specific display object blinks) on the display device 17.

Third Level: The CPU executes both the second-level notification control and the above-described adaptation control.

### EXAMPLE 2 OF COMBINATION

First Level: The CPU executes notification control for displaying a static image of a specific display object on the display device 17 and outputting alert sound from the sound output device 18.

Second Level: The CPU executes notification control for displaying the static image of the specific display object on the display device 17 and outputting the alert sound at a volume level greater than the first level from the sound output device 18.

Third Level: The CPU executes both the second-level notification control and the above-described adaptation control.

### EXAMPLE 3 OF COMBINATION

First Level: The CPU executes notification control for displaying a static image of a specific display object on the display device 17 and outputting alert sound from the sound output device 18.

Second Level: The CPU executes notification control for displaying video of the specific display object on the display device 17 and outputting the alert sound at a volume level greater than the first level from the sound output device 18.

Third Level: The CPU executes both the second-level notification control and the above-described adaptation control.

The first to third-level driving assistance control may include the notification control while not including the adaptation control. For example, the following combinations may be made.

### EXAMPLE 4 OF COMBINATION

First Level: The CPU executes notification control for displaying a static image of a specific display object on the display device 17.

Second Level: The CPU executes notification control for displaying video of the specific display object on the display device 17 and outputting alert sound from the sound output device 18.

Third Level: The CPU executes notification control for displaying video (video with motion more intense than the second level) of the specific display object on the display device 17 and outputting the alert sound at a volume level greater than the second level from the sound output device 18.

### EXAMPLE 5 OF COMBINATION

First Level: The CPU executes notification control for displaying a static image of a specific display object on the display device 17.

Second Level: The CPU executes notification control for displaying video of the specific display object (for example, a screen on which the specific display object blinks) on the display device 17.

Third Level: The CPU executes notification control for displaying video (for example, a screen on which the specific display object blinks) of the specific display object on the display device 17 and outputting alert sound from the sound output device 18.

In the above-described embodiment, although a configuration in which the assistance level of the driving assistance control has three levels of the first level to the third level has been described, the number of assistance levels of the driving assistance control is not limited to three. That is, the number of assistance levels of the driving assistance control may be two or may be four or more.

In the above-described embodiment, although a configuration in which the detection object DB 27 is stored in the memory 24 of the driving assistance ECU 14 has been described, the disclosure is not limited to such a configuration. For example, a configuration may be made in which the assistance device 10 has a separate memory or storage device (for example, a hard disk or an SSD), and the detection object DB 27 is stored in the memory or storage device.

In the respective embodiments described above, although the vehicle having the engine (internal combustion engine) as a drive power source has been described, the drive power source is not limited to the engine. The disclosure can also be applied to a vehicle (electric vehicle) having a motor (electric motor) as a drive power source, and a vehicle (hybrid vehicle) having an engine and a motor as a drive power source.

What is claimed is:

1. A driving assistance device for a vehicle comprising:
a camera sensor configured to generate image data by imaging scenery forward of a vehicle;
a controller configured to, when determination is made that a specific display object is present forward of the vehicle based on the generated image data, recognize display content of the specific display object determined to be present and execute driving assistance control that is control for assisting driving by a driver of the vehicle corresponding to the display content of the specific display object,
wherein the controller is configured to execute, as the driving assistance control, control where an assistance level representing a degree of influence on the driver is low when determination is made that a rate of coincidence of recognition results that is a proportion of “the number of times in which the recognition results of the display content of the same specific display object are identical” to “the number of times of determination that the same specific display object is present” is less than a first threshold value, compared to when determination is made that the rate of coincidence of the recognition results is equal to or greater than the first threshold value.

2. The driving assistance device according to claim 1, further comprising a notification device configured to notify the driver of information regarding the specific display object,
wherein the controller is configured to
execute, as the driving assistance control, control including notification control for, with the notification device, notifying the driver that determination is made that the specific display object is present and adaptation control that is vehicle control for making a traveling state of the vehicle approach a state adapted to the display content of the specific display object when determination is made that the rate of coincidence of the recognition results is equal to or greater than the first threshold value, and
execute, as the driving assistance control, control including the notification control while not including the adaptation control when determination is made that the rate of coincidence of the recognition results is less than the first threshold value.

3. The driving assistance device according to claim 1, wherein the controller is configured to execute, as the driving assistance control, control where the assistance level is low when determination is made that the number of times of determination that the same specific display object is present is equal to or greater than a predetermined number of times while the rate of coincidence of the recognition results is less than a second threshold value, compared to when determination is made that the number of times of determination that the same specific display object is present is equal to or greater than the predetermined number of times and the rate of coincidence of the recognition results is equal to or greater than the second threshold value.

4. The driving assistance device according to claim 3, further comprising a notification device configured to notify the driver of information regarding the specific display object,
wherein the controller is configured to
execute, as the driving assistance control, control including notification control for, with the notification device, notifying the driver that determination is made that the specific display object is present and adaptation control that is vehicle control for making a traveling state of the vehicle approach a state adapted to the display content of the specific display object when the number of times of determination that the same specific display object is present is equal to or greater than the predetermined number of times and the rate of coincidence of the recognition results is equal to or greater than the second threshold value, and
execute, as the driving assistance control, control including the notification control while not including the adaptation control when determination is made that the number of times of determination that the same specific display object is present is equal to or greater than the predetermined number of times while the rate of coincidence of the recognition results is less than the second threshold value.

5. The driving assistance device according to claim 3, wherein the controller is configured to execute, as the driving assistance control, control where the assistance level is low when the number of times of determination that the same specific display object is present is less than the predetermined number of times, compared to when the rate of coincidence of the recognition results is equal to or greater than the first threshold value.

6. The driving assistance device according to claim 5, wherein the controller is configured to execute, as the driving assistance control, control including notification control while not including adaptation control when the number of times of determination that the same specific display object is present is less than the predetermined number of times.

7. The driving assistance device according to claim 1, further comprising a database in which a position of the specific display object determined to be present by the controller and histories of the recognition results of the display content are registered,
wherein the controller is configured to register the position of the specific display object determined to be present and the recognition results of the display content in the database and calculate the rate of coincidence of the recognition results on the same specific display object with reference to the database.

8. The driving assistance device according to claim 7, wherein the controller is configured to delete the recognition results on the same specific display object from the database while leaving one recognition result when the number of times of determination that the same specific display object is present is equal to or greater than a predetermined number of times and the rate of coincidence of the recognition results is equal to or greater than a second threshold value.

9. The driving assistance device according to claim 7, wherein the controller is configured to delete the recognition results on the specific display object not detected over a predetermined period, from the database.

10. The driving assistance device according to claim 7, wherein the controller is configured to calculate a similarity of the image data and a template prepared in advance for determining the presence of the specific display object, determine that the specific display object is present when the similarity is equal to or greater than a detection threshold value, and not register the recognition results on the specific display object in the database when the similarity is equal to or greater than the detection threshold value while being less than an accuracy threshold value greater than the detection threshold value.

11. The driving assistance device according to claim 7, wherein the controller is configured to delete the recognition results on the same specific display object from the database when the number of times of determination that the same specific display object is present is equal to or greater than a predetermined number of times, the rate of coincidence of the recognition results is equal to or greater than a second threshold value, and a similarity on the same specific display object is equal to or greater than a predetermined threshold value.

12. A driving assistance method for a vehicle comprising:
determining whether or not a specific display object is present forward of a vehicle based on image data acquired by imaging scenery forward of the vehicle;
when determination is made that the specific display object is present forward of the vehicle, recognizing display content of the specific display object determined to be present and executing driving assistance control that is control for assisting driving by a driver of the vehicle corresponding to the display content of the specific display object; and
when determination is made that the specific display object is present forward of the vehicle, determining whether or not a rate of coincidence of recognition results that is a proportion of “the number of times in which the recognition results of the display content of the same specific display object are identical” to “the number of times of determination that the same specific display object is present” is less than a first threshold value,
wherein in the executing of the driving assistance control, control where an assistance level representing a degree of influence on the driver is low is executed as the driving assistance control when determination is made that the rate of coincidence of the recognition results is less than the first threshold value, compared to when determination is made that the rate of coincidence of the recognition results is equal to or greater than the first threshold value.

13. A program causing a computer of a driving assistance device for a vehicle to execute
determining whether or not a specific display object is present forward of a vehicle based on image data acquired by imaging scenery forward of the vehicle,
when determination is made that the specific display object is present forward of the vehicle, recognizing display content of the specific display object determined to be present and executing driving assistance control that is control for assisting driving by a driver of the vehicle corresponding to the display content of the specific display object, and
when determination is made that the specific display object is present forward of the vehicle, determining whether or not a rate of coincidence of recognition results that is a proportion of “the number of times in which the recognition results of the display content of the same specific display object are identical” to “the number of times of determination that the same specific display object is present” is less than a first threshold value,
wherein in the executing of the driving assistance control, control where an assistance level representing a degree of influence on the driver is low is executed as the driving assistance control when determination is made that the rate of coincidence of the recognition results is less than the first threshold value, compared to when determination is made that the rate of coincidence of the recognition results is equal to or greater than the first threshold value.
